(19) United States
(12) Patent Application Publication
(10) Pub. No.: US 2024/0023133 A1
(43) Pub. Date: Jan. 18, 2024

(54) METHOD AND DEVICE FOR RECEIVING AND TRANSMITTING INFORMATION

(71) Applicant: Samsung Electronics Co., Ltd., Suwon-si (KR)

(72) Inventors: Zhe CHEN, Beijing (CN); Feifei SUN, Beijing (CN); Jingxing FU, Beijing (CN); Bin YU, Beijing (CN)

(21) Appl. No.: 18/347,089

(22) Filed: Jul. 5, 2023

(30) Foreign Application Priority Data
Jul. 15, 2022 (CN) 202210837827.2
Nov. 9, 2022 (CN) 202211399607.2

(51) Int. Cl. H04W 72/232; H04W 72/1263; H04W 16/28

(52) U.S. Cl. CPC H04W 72/232; H04W 72/1263; H04W 16/28

(57) ABSTRACT

The disclosure relates to a fifth generation (5G) or sixth generation (6G) communication system for supporting a higher data transmission rate. A method performed by a repeater and the repeater for performing the method, the repeater including a first unit and a second unit is provided. The method includes receiving, by the first unit, downlink control information downlink control information (DCI) from a base station, and when an offset between the DCI and a channel or signal scheduled by the DCI is less than a threshold, determining, by the first unit, a beam for the first unit to receive the channel or signal according to a beam for the second unit or a beam for the first unit.

### CROSS-REFERENCE TO RELATED APPLICATION(S)

This application is based on and claims priority under 35 U.S.C. § 119(a) of a Chinese patent application number 202210837827.2, filed on Jul. 15, 2022, in the Chinese Patent Office, and of a Chinese patent application number 202211399607.2, filed on Nov. 9, 2022, in the Chinese Patent Office, the disclosure of each of which is incorporated by reference herein in its entirety.

### BACKGROUND

### 1. Field

The disclosure relates to a technical field of wireless communication. More particularly, the disclosure relates to a method and device for receiving and transmitting information.

### 2. Description of Related Art

In order to meet the increasing demand for wireless data communication services since the deployment of fourth generation (4G) communication systems, efforts have been made to develop improved fifth generation (5G) or pre-5G communication systems. Therefore, 5G or pre-5G communication systems are also called “Beyond 4G networks” or “Post-long term evolution (LTE) systems”.

In order to achieve a higher data rate, 5G communication systems are implemented in higher frequency (millimeter wave (mmWave)) bands, e.g., 60 gigahertz (GHz) bands. In order to reduce propagation loss of radio waves and increase a transmission distance, technologies, such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, or the like.

In 5G systems, hybrid frequency shift keying (FSK) and quadrature amplitude modulation (QAM) (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

The transmission from a base station to a user equipment (UE) is called downlink, and the transmission from a UE to a base station is called uplink.

5G mobile communication technologies define broad frequency bands such that high transmission rates and new services are possible, and can be implemented not only in “Sub 6 GHz” bands, such as 3.5 GHz, but also in “Above 6 GHz” bands referred to as mmWave including 28 GHz and 39 GHz. In addition, it has been considered to implement sixth generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and device for receiving and transmitting information.

Additional aspects will be set forth in part in the description which follows and, in part, will be apparent from the description, or may be learned by practice of the presented embodiments.

In accordance with an aspect of the disclosure, a method performed by a repeater, the repeater comprising a first unit and a second unit is provided. The method includes receiving, by the first unit, downlink control information (DCI) from a base station, and when an offset between the DCI and a channel or signal scheduled by the DCI is less than a threshold, determining, by the first unit, a beam for the first unit to receive the channel or signal according to a beam for the second unit or a beam for the first unit.

In an aspect, the second unit performs downlink reception in time domain resources of the channel or signal scheduled by the DCI.

In another aspect, the method further includes providing, by the first unit, repeater capability information to the base station, the repeater capability information indicating at least one of the followings the repeater not supporting to simultaneously perform reception of the channel or signal by the first unit and downlink reception by the second unit using different spatial parameters, the repeater supporting beam sweeping, the repeater supporting adaptive beams, the repeater supporting beam correspondence, the repeater supporting independent beam indication for the first unit and the second unit.

In another aspect, the beam for the second unit, the beam for the first unit and/or the beam for the first unit to receive the channel or signal comprise at least one of the followings a spatial filter, a quasi-co-location (QCL) assumption, a QCL parameter, a transmission control indication (TCI) state, spatial relationship.

In accordance with another aspect of the disclosure, a method performed by a repeater, the repeater including a first unit and a second unit is provided. The method includes if first time domain resources overlap with second time domain resources, performing, by the repeater, at least one of the following operations the second unit performing downlink reception and/or uplink forwarding according to a beam for a channel or signal indicated by the base station to the first unit, the second unit not performing downlink reception and/or uplink forwarding, the first unit receiving and/or transmitting the channel or signal indicated by the base station to the first unit according to a beam for the second time domain resources, the first unit not receiving and/or not transmitting the channel or signal indicated by the base station to the first unit, wherein the first time domain resources are time domain resources for the channel or signal indicated by the base station to the first unit, the second time domain resources are time domain resources used by the second unit for downlink reception and/or uplink forwarding.

In another aspect, the method further includes providing, by the first unit, repeater capability information to the base station, the repeater capability information indicating at least one of the followings the repeater not supporting to simultaneously perform reception of the channel or signal by the first unit and downlink reception by the second unit using different spatial parameters, the repeater not supporting to simultaneously perform transmission of the channel or signal by the first unit and uplink forwarding by the second unit using different spatial parameters, the repeater supporting beam sweeping, the repeater supporting adaptive beams, the repeater supporting beam correspondence, the repeater supporting independent beam indication for the first unit and the second unit.

In another aspect, a beam for the channel or signal is different from the beam for the second time domain resources.

In another aspect, the second unit performing downlink reception and/or uplink forwarding according to the beam for the channel or signal indicated by the base station to the first unit includes one of the following, the second unit performing downlink reception and/or uplink forwarding according to the beam for the channel or signal in an overlapping portion of the first time domain resources and the second time domain resources, the second unit performing downlink reception and/or uplink forwarding in the first time domain resources according to the beam for the channel or signal, the second unit performing downlink reception and/or uplink forwarding in the second time domain resources according to the beam for the channel or signal.

In another aspect, the second unit not performing downlink reception and/or uplink forwarding includes one of the following, the second unit not performing downlink reception and/or uplink forwarding in an overlapping portion of the first time domain resources and the second time domain resources, the second unit not performing downlink reception and/or uplink forwarding in the first time domain resources, the second unit not performing downlink reception and/or uplink forwarding in the second time domain resources.

In another aspect, the first unit receiving and/or transmitting the channel or signal indicated by the base station to the first unit according to the beam for the second time domain resources includes one of the following, the first unit receiving and/or transmitting the channel or signal according to the beam for the second time domain resources in an overlapping portion of the first time domain resources and the second time domain resources, the first unit receiving and/or transmitting the channel or signal in the first time domain resources according to the beam for the second time domain resources, the first unit receiving and/or transmitting the channel or signal in the second time domain resources according to the beam for the second time domain resources.

In another aspect, the first unit not receiving and/or not transmitting the channel or signal indicated by the base station to the first unit includes one of the following, the first unit not receiving and/or not transmitting the channel or signal in an overlapping portion of the first time domain resources and the second time domain resources, the first unit not receiving and/or not transmitting the channel or signal in the first time domain resources, the first unit not receiving and/or not transmitting the channel or signal in the second time domain resources.

In accordance with another aspect of the disclosure, a method performed by a base station is provided. The method includes transmitting downlink control information DCI to a repeater, wherein, when an offset between the DCI and a channel or signal scheduled by the DCI is less than a threshold, a beam for the repeater to receive the channel or signal is determined according to a beam for the repeater.

Another aspect of the disclosure is to provide a repeater comprising a first unit and a second unit and configured to perform corresponding methods described above.

Another aspect of the disclosure is to provide a repeater comprising a transceiver and at least one processor coupled to the transceiver, the at least one processor is configured to perform corresponding methods described above.

Another aspect of the disclosure is to provide a base station comprising a transceiver and at least one processor coupled to the transceiver, the at least one processor is configured to perform corresponding methods described above.

Another aspect of the disclosure is to provide a method and device for receiving and transmitting information/signals, which can improve the performance of a network-controlled repeater (NCR).

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an overall structure of a wireless communication network according to an embodiment of the disclosure;

FIG. 2A illustrates a transmission path in a wireless communication network according to various embodiments of the disclosure;

FIG. 2B illustrates a reception path in a wireless communication network according to various embodiments of the disclosure;

FIG. 3A illustrates a structure of a user equipment (UE) in a wireless communication network according to various embodiments of the disclosure;

FIG. 3B illustrates a structure of a base station in a wireless communication network according to various embodiments of the disclosure;

FIG. 4 illustrates a network including a repeater NCR according to an embodiment of the disclosure;

FIG. 5 illustrates a structure of an NCR according to an embodiment of the disclosure;

FIG. 6 illustrates a method performed by an NCR according to an embodiment of the disclosure;

FIG. 7 illustrates a method performed by an NCR according to an embodiment of the disclosure;

FIG. 8 illustrates a method performed by a base station according to an embodiment of the disclosure;

FIG. 9 illustrates a structure of a base station according to an embodiment of the disclosure; and

FIG. 10 illustrates a structure of an NCR according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, some elements may be exaggerated, omitted or schematically shown in the drawings. In addition, the size of each component does not fully reflect the actual size. In the drawings, the same or corresponding elements have the same reference numerals.

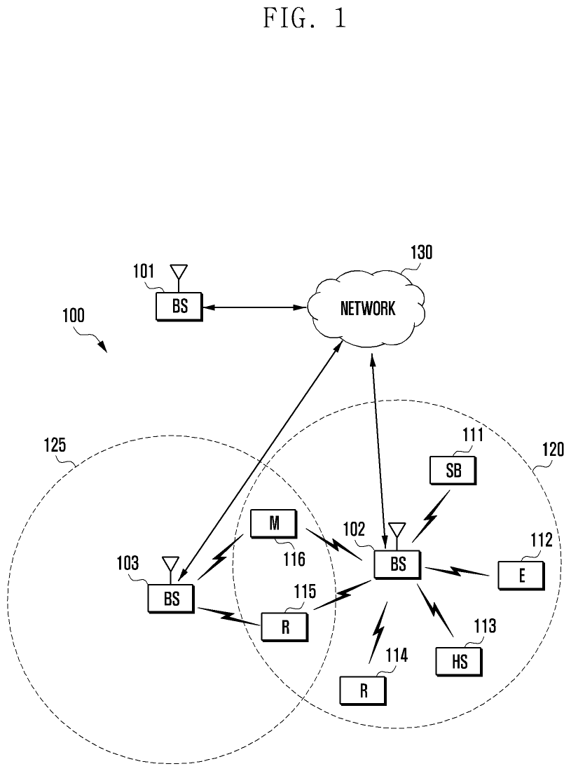

FIG. 1 illustrates a wireless network according to an embodiment of the disclosure.

Referring to FIG. 1, an embodiment of a wireless network 100 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms, such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms, such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of user equipments (UEs) within a coverage area 120 of gNB 102. The first plurality of UEs include a UE 111, which may be located in a small business (SB), a UE 112, which may be located in an enterprise (E), a UE 113, which may be located in a wireless fidelity (Wi-Fi) Hotspot (HS), a UE 114, which may be located in a first residence (R), a UE 115, which may be located in a second residence (R), a UE 116, which may be a mobile device (M), such as a cellular phone, a wireless laptop computer, a wireless personal digital assistant (PDA), or the like. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, long term evolution (LTE), LTE-advanced (LTE-A), worldwide interoperability for microwave access (WiMAX) or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described below, one or more of gNB 101, gNB 102, and gNB 103 include a two-dimensional (2D) antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

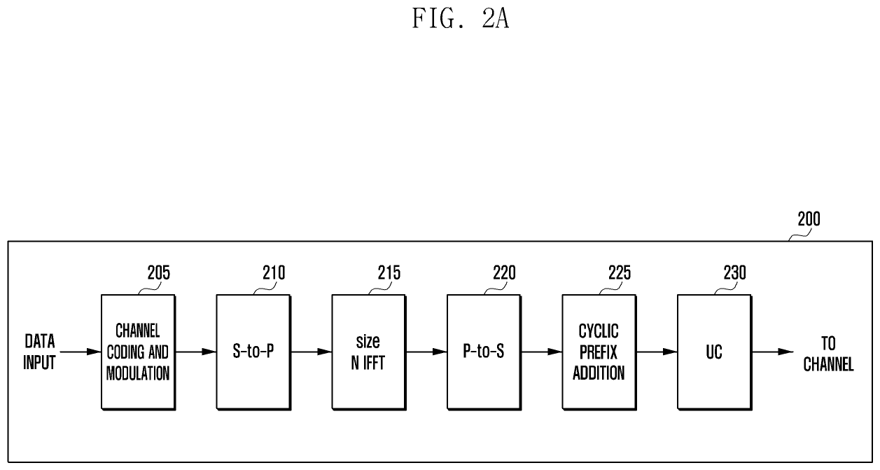

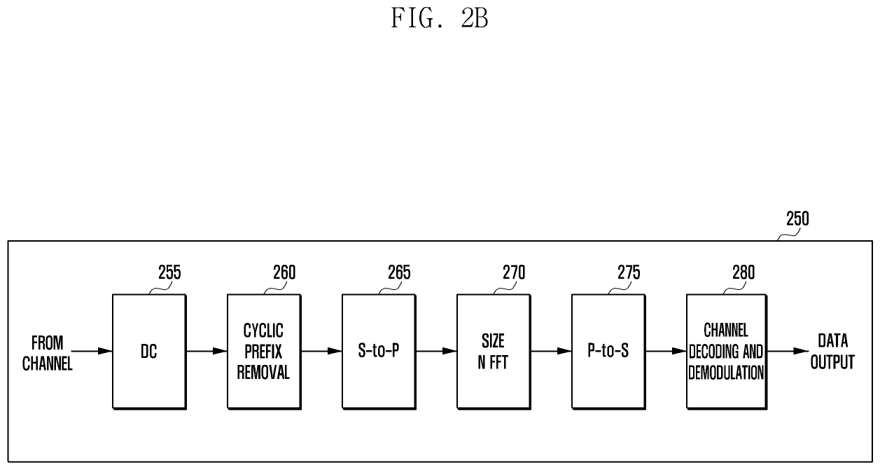

FIGS. 2A and 2B illustrate a wireless transmission and reception paths according to various embodiments of the disclosure.

Referring to FIGS. 2A and 2B, in the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230. The reception path 250 includes a down-converter (DC) 255, a cyclic prefix removal block 260, a serial-to-parallel (S-to-P) block 265, a size N fast Fourier transform (FFT) block 270, a parallel-to-serial (P-to-S) block 275, and a channel decoding and demodulation block 280.

In the transmission path 200, the channel coding and modulation block 205 receives a set of information bits, applies coding (such as low density parity check (LDPC) coding), and modulates the input bits (such as using quadrature phase shift keying (QPSK) or quadrature amplitude modulation (QAM)) to generate a sequence of frequency-domain modulated symbols. The serial-to-parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The parallel-to-serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to a radio frequency (RF) frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The serial-to-parallel block 265 converts the time-domain baseband signal into a parallel time-domain signal. The size N FFT block 270 performs an FFT algorithm to generate N parallel frequency-domain signals. The parallel-to-serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is turned only illustrative and should not be interpreted as limiting the scope of the disclosure. Other types of transforms can be used, such as discrete Fourier transform (DFT) and inverse discrete Fourier transform (IDFT) functions. It should be understood that for DFT and IDFT functions, the value of variable N may be any integer (such as 1, 2, 3, 4, or the like), while for FFT and IFFT functions, the value of variable N may be any integer which is a power of 2 (such as 1, 2, 4, 8, 16, or the like).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

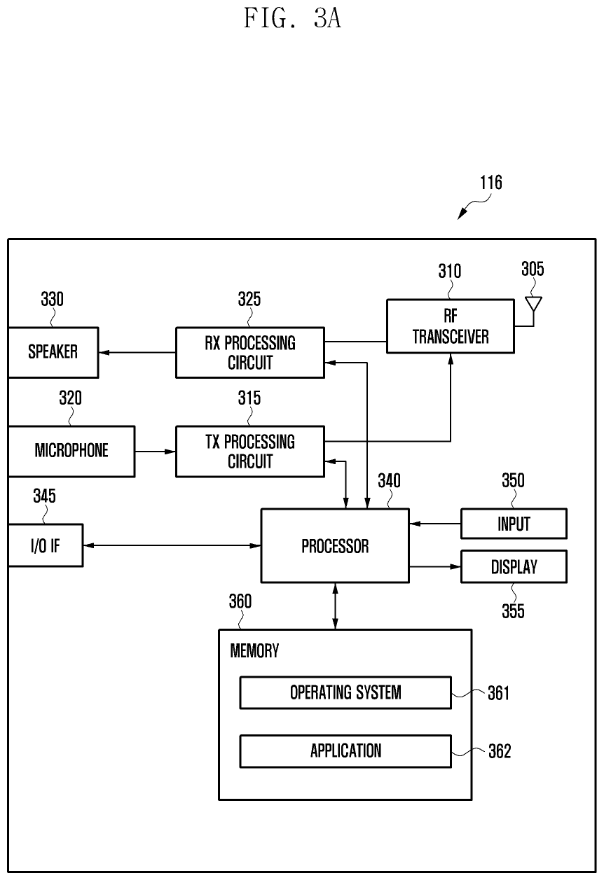

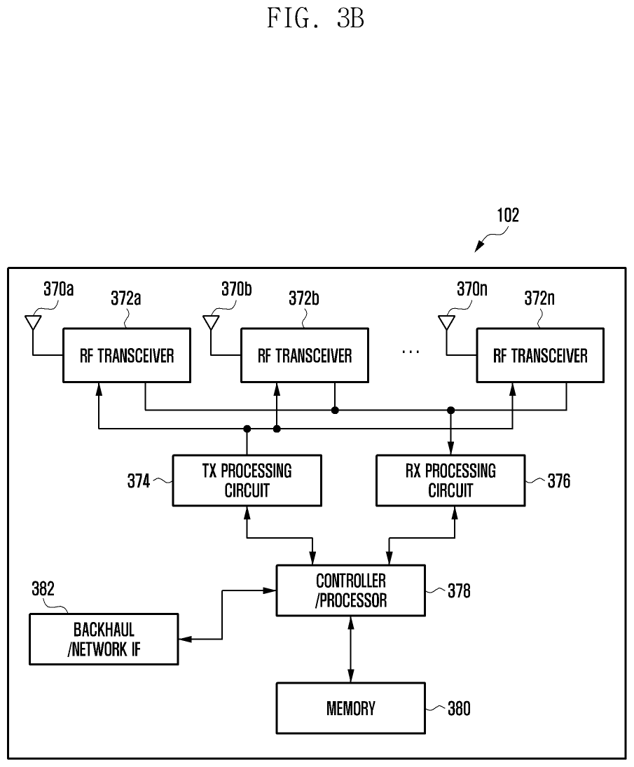

FIG. 3A illustrates a UE according to an embodiment of the disclosure.

Referring to FIG. 3A, the UE 116 and UEs 111-115 of FIG. 1 can have the same or similar configuration. However, a UE has various configurations, and FIG. 3A does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices, such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates a gNB according to an embodiment of the disclosure.

Referring to FIG. 3B, the gNB 102 and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

Referring to FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a blind interference sensing (BIS) process, such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities, such as web real-time communications (RTCs). The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described below, the transmission and reception paths of gNB 102 (implemented using RF transceivers 372a-372n, TX processing circuit 374 and/or RX processing circuit 376) support aggregated communication with frequency-division duplexing (FDD) cells and time-division duplexing (TDD) cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

In order to enhance the coverage of a 5G wireless communication system, one method is to set up a repeater at the edge of a cell (or an area with poor cell signal coverage). Generally, a repeater is usually divided into two sides, a base station side and a terminal side.

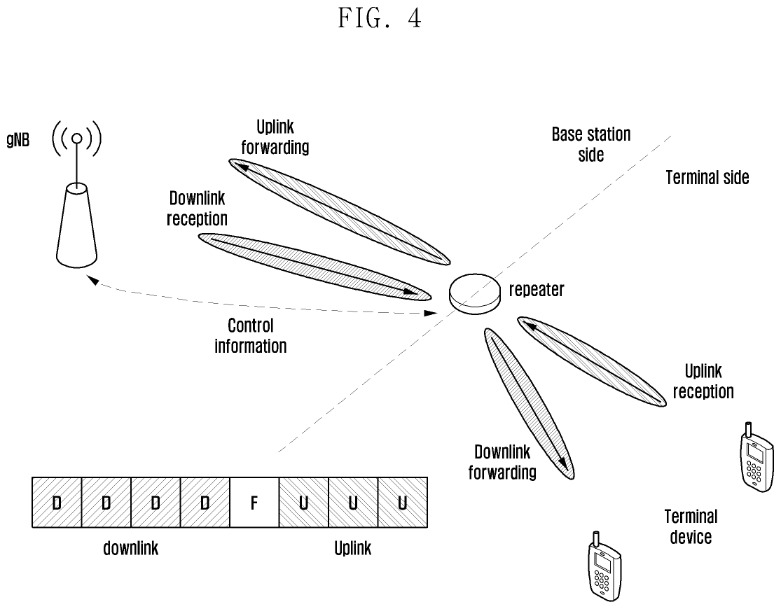

FIG. 4 illustrates a network including an NCR according to an embodiment of the disclosure.

Referring to FIG. 4, for the downlink of a base station, the repeater receives radio frequency (RF) signals from the base station. These RF signals pass through a built-in amplifier in the repeater and the amplified signals are transmitted to the terminal device at the terminal side of the repeater. For the uplink of the base station, the repeater receives radio frequency (RF) signals from the terminal device at the terminal side. These RF signals pass through the built-in amplifier in the repeater and the amplified signals are transmitted to the base station at the base station side of the repeater.

Generally, the existing repeater cannot be controlled by the base station. For example, the on/off of the repeater, the timing of uplink and downlink forwarding and the direction of uplink and downlink forwarding are all achieved through techniques implemented by the repeater itself/in a way of manual setting adjustment, which is not beneficial to the flexibility of network distribution and the coverage of the repeater. In order to overcome the above shortcomings, one solution is to integrate a terminal device for the repeater, which can communicate with network devices (e.g., base stations) in order to flexibly control the repeater. Such a repeater integrated with the terminal device is called a network-controlled repeater, NCR.

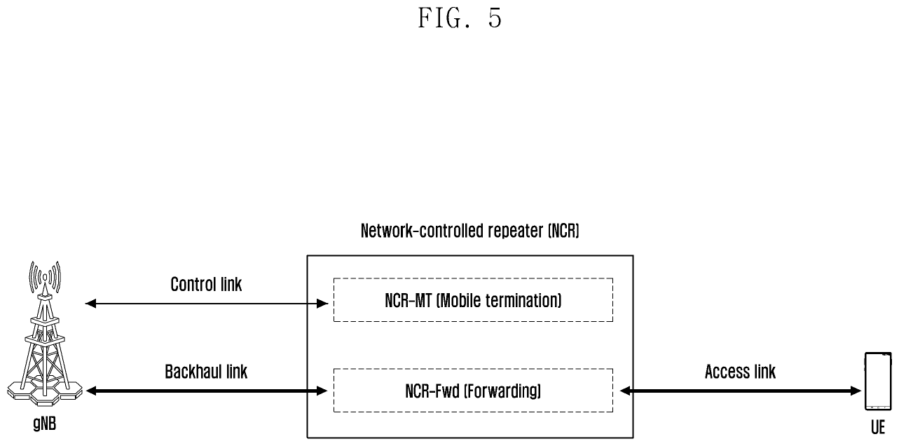

FIG. 5 illustrates a structure of the NCR according to an embodiment of the disclosure.

Referring to FIG. 5, the NCR has two functional entities: a first unit and a second unit. More particularly, in this disclosure, take the network-controlled repeater mobile terminal (NCR-MT) as an example of the first unit, and the network-controlled repeater forwarder (NCR-Fwd) as an example of the second unit, in which:

The NCR-MT is defined as a functional entity for information exchange (for example, side control information) with the base station. Here, the link between the NCR-MT and the base station is called a control link (C-link). In addition, the side control information is at least used to control the NCR-Fwd.

The NCR-Fwd is defined as a functional entity for amplifying and forwarding radio frequency signals (e.g., uplink/downlink radio frequency signals) between the base station and a UE. The link between the NCR-Fwd and the base station is called a backhaul link; and the link between the NCR-Fwd and the UE is called an access link.

In this disclosure, the NCR can refer to NCR-MT or NCR-Fwd, or a combination of both. Optionally, the NCR-MT can also be equivalently understood as a UE, that is, it can be equivalently understood as a terminal device (UE).

In order to avoid ambiguity, corresponding names are defined here for transmission and reception behaviors of the repeater. Referring back to FIG. 4, for the NCR, or for the NCR-Fwd, radio frequency signal reception for downlink (or radio frequency signal reception at the base station side; or radio frequency signal reception on the backhaul link) is called downlink reception; radio frequency signal transmission for downlink (or radio frequency signal transmission at the terminal side; or radio frequency signal forwarding to the terminal; or radio frequency signal transmission on the access link) is called downlink forwarding; radio frequency signal reception for uplink (or radio frequency signal reception at the terminal side; or radio frequency signal reception on the access link) is called uplink reception; radio frequency signal transmission for uplink (or radio frequency signal transmission at the base station side; or radio frequency signal forwarding to the base station; or radio frequency signal transmission on the backhaul link) is called uplink forwarding.

The current NCR has following problems:

#1. At present, there is no method to indicate the default beam for the NCR-MT, especially when the NCR-Fwd performs downlink forwarding, there is no method to indicate the default beam for a channel or signal to be received by the NCR-MT. This means that the beam to be used by the NCR-MT to receive the channel or signal is unclear, which leads to the degradation of transmission quality on the control link, and further leads to the reduction of reliability for the NCR in receiving and/or transmitting control information.

#2. On the same time domain resources, beam indications for the NCR-MT and the NCR-Fwd may be different, that is, there are both beam indication for the NCR-MT and beam indication for the NCR-Fwd in the time domain resources. In this case, especially when NCR hardware capability is limited (for example, only one beam is supported simultaneously), the NCR-MT and the NCT-Fwd cannot use these beam indications to receive and/or transmit simultaneously. At present, there is no corresponding method to deal with this situation, which will lead to reception and/or transmission beams of the NCR are unclear, which may lead to the degradation of link quality between the NCR and the base station and has impact to the performance of the communication system.

In order to address at least one of the above issues, the disclosure proposes a number of methods for indicating the default beam for the NCR-MT or handling beam collision between the NCR-MT and the NCR-Fwd. These methods can avoid the problem of beam indication ambiguity for the NCR, thus improving the link quality between the NCR and the base station, improving the coverage and/or reliability of the NCR, and improving the performance of the communication system. Details will be described below through embodiments and examples.

### Embodiment 1 (NCR-MT Default Beam Determination)

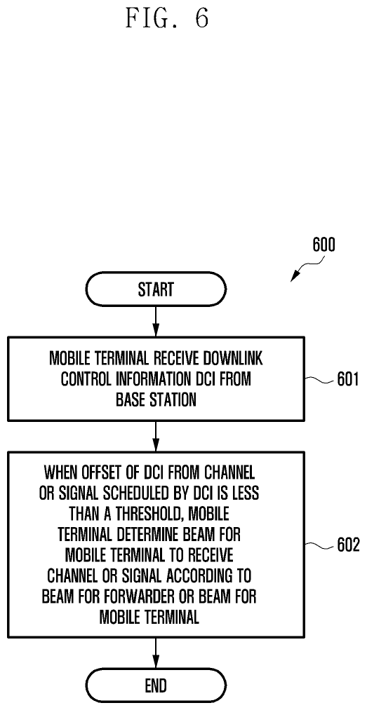

FIG. 6 illustrates a method performed by an NCR according to an embodiment of the disclosure.

Referring to FIG. 6, the NCR includes the NCR-MT and the NCR-Fwd.

The method 600 includes, at operation 601, the NCR-MT receives downlink control information (DCI) from the base station; at operation 602, when an offset between the DCI and a channel or signal scheduled by the DCI is less than a threshold, the NCR-MT determines a beam for the NCR-MT to receive the channel or signal according to a beam for the NCR-Fwd or a beam for the NCR-MT.

When the offset between the DCI reception by the NCR-MT and a channel or a signal corresponding to the DCI (i.e., the offset between the DCI and the channel (e.g., physical downlink control channel (PDCCH)) or the signal scheduled/indicated by the DCI) is less than the threshold, the NCR-MT determines the beam for the NCR-MT to receive the channel or signal scheduled by the DCI according to the beam corresponding to the NCR-Fwd or the beam corresponding to the NCR-MT. This will be described with examples. The above procedure can be understood as that the NCR obtains the beam corresponding to the NCR-Fwd or the NCR-MT of the NCR. The NCR determines the default beam for the NCR-MT according to the beam corresponding to the NCR-Fwd or the NCR-MT. Here, the beam can be understood as at least one of a TCI state, QCL assumption, indicated QCL, QCL parameters, and spatial filter (for example, a spatial filter corresponding to a QCL-typeD reference signal). Optionally, the beam for the NCR-Fwd may be indicated by the base station or determined by the NCR-MT.

Optionally, the NCR-Fwd performs downlink reception on time domain resources related to the channel or signal (time domain resources for the channel or signal, or time domain resources for channel or signal reception). This can be understood as that the NCR-Fwd is in an ON state in the time domain resources (for downlink reception and/or forwarding) related to the channel or signal. Optionally, the time domain resources related to the channel or signal refer to slots (for example, at least one slot or all slots) associated/corresponding to the channel or signal. Optionally, the time domain resources related to the channel or signal refer to symbols (e.g., at least one symbol or all symbols) to which the channel or signal is associated/corresponding or where the channel or signal is located. Optionally, the time domain resources related to the channel or signal refer to subframes (for example, at least one subframe or all subframes) to which the channel or signal is associated/corresponding or where the channel or signal is located.

Optionally, when the NCR-Fwd is in the ON state, the NCR-MT adopts a default beam (at this time, follows the beam indication corresponding to the NCR-Fwd); when the NCR-Fwd is in an OFF state (or when the NCR-Fwd is not in the ON state), the NCR-MT adopts another default beam (at this time, for example, follows the default beam for the UE described in the existing standards). Further explanation is made below through specific examples (for the beam for the NCR-Fwd and the beam for the NCR-MT, respectively).

### Example 1-1 (NCR-Fwd, Physical Downlink Shared Channel (PDSCH))

In this example, take a PDSCH as an example of the channel or signal. Take the beam for the NCR-Fwd as an example of the beam for the NCR-Fwd or the NCR-MT.

The NCR determines the default beam for the NCR-MT to receive the PDSCH according to the beam for the NCR-Fwd. For example, when the offset (e.g., scheduling offset) of reception of the DCI from the PDSCH corresponding to the DCI is less than a threshold (e.g., timeDurationForQCL), the NCR-MT of the NCR determines the QCL assumption or TCI state of the PDSCH according to the beam for the NCR-Fwd. In other words, when the offset (e.g., scheduling offset) of reception of the DCI from the PDSCH corresponding to the DCI is less than the threshold (e.g., timeDurationForQCL), the NCR-MT determines that the TCI state/QCL assumption related to the NCR-Fwd is the same as the TCI state/QCL assumption corresponding to the PDSCH. In other words, when the offset (e.g., scheduling offset) of reception of the DCI from the PDSCH corresponding to the DCI is less than the threshold (e.g., timeDurationForQCL), the NCR-MT determines that a reference signal related to the NCR-Fwd and DM-RS port(s) of the PDSCH are QCLed.

Optionally, the beam for the NCR-Fwd refers to at least one of the followings (or is determined by one of the following methods):

Method 1

The transmission configuration indication (TCI) state corresponding to (or indicated for) the NCR-Fwd. For example, an identification (ID) of the TCI state is explicitly indicated by the base station. Further, the ID of the reference signal is the ID indicated by radio resource control (RRC), medium access control-control element (MAC-CE) or DCI signaling and applied to the NCR-Fwd. For example, the TCI state is an activated TCI state of a CORESET, and a CORESET ID is explicitly indicated by the base station. Optionally, the CORESET ID is the CORESET ID indicated by RRC, MAC-CE or DCI signaling and applied to the NCR-Fwd. Optionally, for these examples, the TCI state refers to at least one of a unified TCI state, a joint TCI state, a downlink TCI state, and an uplink TCI state.

Method 2

The QCL assumption corresponding to (or indicated for) the NCR-Fwd. For example, the QCL assumption is the QCL assumption corresponding to the TCI state of the NCR-Fwd. For another example, the QCL assumption is the QCL assumption corresponding to a CORESET, and the CORESET ID is explicitly indicated by the base station. Optionally, the CORESET ID is the CORESET ID indicated by RRC, MAC-CE or DCI signaling and applied to the NCR-Fwd.

Method 3

The reference signal corresponding to (or indicated for) the NCR-Fwd. For example, an ID of the reference signal is explicitly indicated by the base station. Optionally, the ID of the reference signal is the ID of the reference signal indicated by RRC, MAC-CE or DCI signalling and applied to the NCR-Fwd. Optionally, the reference signal refers to at least one of a single-sideband modulation (SSB) and a channel state information reference signal (CSI-RS).

Optionally, the reference signal corresponding to the NCR-Fwd refers to at least one of the followings:
A QCL-typeA and/or QCL-typeD reference signal of the TCI state corresponding to the NCR-Fwd;
A QCL-typeA and/or QCL-typeD reference signal of the TCI state indicated for the NCR-Fwd;
A QCL-typeA and/or QCL-typeD reference signal of the QCL assumption corresponding to the NCR-Fwd;
A QCL-typeA and/or QCL-typeD reference signal of the QCL assumption indicated for the NCR-Fwd.

Optionally, a cell/component carrier (CC) (of the NCR-MT) corresponding to the TCI state is at least one of the followings:
a primary cell (PCell)/primary secondary cell (PSCell)/SpCell (SpCell=PCell+PS Cell);
a cell/CC with the smallest ID;
a cell/CC with the smallest ID in a frequency band. Optionally, this frequency band refers to the frequency band of FR2. Optionally, this frequency band refers to the frequency band where the NCR-Fwd operates;
a cell/CC in FR2 (or a cell configured with a QCL-typeD reference signal);
a cell/CC in the same frequency band as the NCR-Fwd;
a Secondary Cell (SCell);
a cell/CC scheduled across carriers;
a CC that is not configured with a CORESET.

Optionally, a bandwidth portion (BWP) (of the NCR-MT) corresponding to the TCI state is at least one of the followings:
an active BWP;
a BWP with the smallest ID;
an initial BWP;
a DL BWP;
an UL BWP;
all (configured) BWPs of a cell;
a BWP that is not configured with a CORESET.

For the method provided in Example 1-1, the NCR also satisfies the following condition: the NCR-Fwd is turned on in time domain resources related to the PDSCH (that is, the NCR-Fwd performs downlink reception and/or downlink forwarding in the time domain resources related to the PDSCH).

When the NCR-Fwd is not turned on in the time domain resources related to the PDSCH, the default reception beam for the NCR-MT is at least one of the followings:
a QCL assumption corresponding to the CORESET with the lowest ID in the latest slot in an active BWP. Optionally, in the active BWP, at least one CORESET is monitored;
an activated TCI state with the lowest ID for the PDSCH in an active BWP. Optionally, in the active BWP, no CORESET is monitored.

### Example 1-2 (NCR-MT, PDSCH)

In this example, take a PDSCH as an example of the channel or signal. Take the beam for the NCR-MT as an example of the beam for the NCR-Fwd or the NCR-MT.

The NCR determines the default beam for the NCR-MT to receive the PDSCH according to the beam for the NCR-MT. For example, when the offset (e.g., scheduling offset) of reception of the DCI from the PDSCH corresponding to the DCI is less than a threshold (e.g., timeDurationForQCL), the NCR-MT of the NCR determines the QCL assumption or TCI state of the PDSCH according to the beam for the NCR-MT of the NCR. In other words, when the offset (e.g., scheduling offset) of reception of the DCI from the PDSCH corresponding to the DCI is less than the threshold (e.g., timeDurationForQCL), the NCR-MT of the NCR determines that the TCI state/QCL assumption related to the NCR-MT of the NCR is the same as the TCI state/QCL assumption corresponding to the PDSCH. In other words, when the offset (e.g., scheduling offset) of reception of the DCI from the PDSCH corresponding to the DCI is less than the threshold (e.g., timeDurationForQCL), the NCR-MT of the NCR determines that a reference signal related to the NCR-MT of the NCR and DM-RS port(s) of PDSCH are QCLed.

Optionally, the beam for the NCR-MT refers to at least one of the followings (or is determined by one of the following methods):

Method 1

The TCI state corresponding to (indicated for) the NCR-MT. Optionally, the TCI state refers to at least one of a unified TCI state, a joint TCI state, a downlink TCI state, and an uplink TCI state. Optionally, the TCI state is a TCI state for at least one of a PDCCH, a PDSCH and a CSI-RS.

Optionally, a cell/CC corresponding to the TCI state is at least one of the followings:
a PCell/PSCell/SpCell;
a cell/CC with the smallest ID;
a cell/CC with the smallest ID in a frequency band. Optionally, this frequency band refers to the frequency band of FR2. Optionally, this frequency band refers to the frequency band where the NCR-Fwd operates;
a cell/CC in FR2 (or a cell with a QCL-typeD reference signal);
a cell/CC in the same frequency band as the NCR-Fwd;
a SCell;
a cell/CC scheduled across carriers;
a CC that is not configured with a CORESET.

Optionally, a BWP corresponding to the TCI state is at least one of the followings:
an active BWP;
a BWP with the smallest ID;
an initial BWP;
a DL BWP;
an UL BWP;
all (configured) BWP of a cell;
a BWP that is not configured with a CORESET.

Method 2

PDCCH beam information corresponding to (or indicated for) the NCR-MT. Optionally, the PDCCH beam information refers to at least one (or combination) of the followings:
a (configurated/activated/indicated/applied) TCI state of a CORESET;
a (configurated/activated/indicated/applied) QCL assumption of a CORESET;
a QCL assumption/indication of a CORESET;
a QCL-typeD reference signal corresponding to a TCI state of a CORESET;
a QCL-typeD reference signal corresponding to a QCL assumption/indication of a CORESET.

Optionally, a cell/CC corresponding to the CORESET is at least one of the followings:
a PCell/PsCell/SpCell;
a SCell;
a cell/CC with the smallest ID;
a cell/CC with the smallest ID in a frequency band. Optionally, this frequency band refers to the frequency band of FR2. Optionally, this frequency band refers to the frequency band where the NCR-Fwd operates;
a cell/CC in the same frequency band as the NCR-Fwd;
a cell/CC of FR2 (in other words, a cell configured with a QCL-typeD reference signal; or a cell configured with at least one TCI state including a QCL-typeD reference signal).

Optionally, a BWP corresponding to the CORESET is at least one of the followings:
an active BWP;
a BWP with the smallest ID;
an initial BWP;
a DL BWP, for example, in case that the TCI state is a DL TCI state or a joint TCI state;
all (configured) BWPs of a cell.

Optionally, an ID corresponding to the CORESET is:
the smallest ID, that is, a CORESET with the smallest ID;
0, that is CORESET #0.

Optionally, the CORESET includes (or does not include) at least one of the following search spaces:
a USS;
a CSS;
a Type 3 CSS.

Optionally, the CORESET refers to a CORESET with the smallest ID in an active BWP of a cell/CC. Optionally, the cell/CC refers to at least one of the followings:
a PCell;
a SCell;
a cell/CC with the smallest ID;
a cell/CC in the same frequency band as the NCR-Fwd;
a cell/CC in FR2 (in other words, a cell configured with a QCL-typeD reference signal; or a cell configured with at least one TCI state including a QCL-typeD reference signal).

Optionally, a (configured/activated/indicated/applied) QCL assumption of the CORESET refers to a QCL assumption of the CORESET in the latest slot. For example, a PDCCH quasi-co-location indication of the CORESET (associated with the monitored search space) with the lowest CORESET ID in the latest slot (in which one or more CORESETs in an active BWP of a serving cell/CC are monitored by the NCR-MT). Optionally, the serving cell/CC refers to:
a PCell;
a SCell;
a cell/CC with the smallest ID;
a cell/CC in the same frequency band as the NCR-Fwd;
a cell/CC in FR2 (in other words, a cell configured with a QCL-typeD reference signal; or a cell configured with at least one TCI state including a QCL-typeD reference signal).

Optionally, a (configured/activated/indicated/applied) TCI state of the CORESET refers to:
one of the configured TCI states corresponding to the CORESET (the first or the one with the smallest TCI state ID). For example, RRC (tci-StatesPDCCH-ToAddList and/or tci-StatesPDCCH-ToReleaseList) configures one or more TCI states for the CORESET, the TCI state is the first of the one or more TCI states.
the first of the activated TCI states/codepoints corresponding to the CORESET. For example, MAC-CE activates one or more TCI states/codepoints for the CORESET, the TCI state/codepoint is the first of the one or more TCI states/codepoints.

Method 3

PDSCH beam information corresponding to (or indicated for) the NCR-MT. Optionally, the PDSCH beam information refers to at least one of the followings:

a (configured/activated/indicated/applied) TCI state of the PDSCH

a (configured/activated/indicated/applied) QCL assumption of the PDSCH

Optionally, the (configured/activated/indicated/applied) TCI state of the PDSCH refers to:
one of the configured TCI states of the PDSCH (the first or the one with the smallest TCI state ID). For example, RRC (tci-StatesPDCCH-ToAddList and/or tci-StatesPDCCH-ToReleaseList) configures one or more TCI states for the PDSCH, the TCI state is the first or the one with the smallest TCI state ID of the one or more TCI states.
one of the activated TCI states of the PDSCH (the first or the one with the smallest TCI state ID). For example, MAC-CE activates one or more TCI states (PDSCH TCI states), the TCI state is the first (or the one with the smallest TCI state ID) of the one or more TCI states.

TCI state(s) corresponding to one of the TCI codepoints (the lowest codepoint). Optionally, the association between a TCI state and a TCI codepoint is indicated by MAC-CE.

Optionally, a cell/CC corresponding to the PDSCH beam information is at least one of the followings:
a PCell;
a SCell;
a cell/CC with the smallest ID;
a cell/CC in the same frequency band as the NCR-Fwd;
a cell/CC with the smallest ID in a frequency band. Optionally, this frequency band refers to the frequency band of FR2. Optionally, this frequency band refers to the frequency band where the NCR-Fwd operates;
a cell/CC in FR2 (or a cell with a QCL-typeD reference signal);
a cell/CC scheduled across carriers;
a CC that is not configured with a CORESET.

Optionally, a BWP corresponding to the PDSCH beam information is at least one of the followings:
an active BWP;
a BWP with the smallest ID;
an initial BWP;
a DL BWP, for example, in case that the TCI state is a DL TCI state or a joint TCI state;
all (configured) BWP of a cell;
a BWP that is not configured with a CORESET.

Method 4

A reference signal corresponding to (or indicated for) the NCR-MT.

Optionally, the reference signal refers to at least one of the followings:
a reference signal identified by the NCR-MT during initial access;
a reference signal identified by the NCR-MT during random access procedure initiated by the reconfiguration with synchronization process;
a reference signal identified by the NCR-MT during beam failure recovery (BFR) procedure (link recovery procedure). In other words, the reference signal (q_{new}) identified by the NCR-MT from a candidate beam reference signal list.

Optionally, a cell/CC corresponding to the reference signal is at least one of the followings:
a PCell;
a SCell;
a cell/CC with the smallest ID;
a cell/CC in the same frequency band as the NCR-Fwd;
a cell/CC with the smallest ID in a frequency band. Optionally, this frequency band refers to the frequency band of FR2. Optionally, this frequency band refers to the frequency band where the NCR-Fwd operates;
a cell/CC in FR2 (or a cell with a QCL-typeD reference signal);
a cell/CC scheduled across carriers;
a CC that is not configured with a CORESET.

Optionally, a BWP corresponding to the reference signal is at least one of the followings:
an active BWP;
a BWP with the smallest ID;
an initial BWP;
a DL BWP;
all (configured) BWP of a cell;
a BWP that is not configured with a CORESET;
a CC that is not configured with a CORESET.

For the method provided in Example 1-2, the NCR also satisfies the following condition: the NCR-Fwd is turned on in time domain resources related to the PDSCH (that is, the NCR-Fwd performs downlink reception and/or downlink forwarding in the time domain resources related to the PDSCH).

When the NCR-Fwd is not turned on in the time domain resources related to the PDSCH, the default reception beam for the NCR-MT is at least one of the followings:

a QCL assumption corresponding to the CORESET with the lowest ID in the latest slot on an active BWP. Optionally, on the active BWP, at least one CORESET is monitored;

an activated TCI state with the lowest ID for the PDSCH on an active BWP. Optionally, on the active BWP, no CORESET is monitored.

### Example 2-1 (NCR-Fwd, CSI-RS)

In this example, take a CSI-RS as an example of the channel or signal. Take the beam for the NCR-Fwd as an example of the beam for the NCR-Fwd or the NCR-MT.

The NCR determines the default beam for the NCR-MT to receive the CSI-RS according to the beam for the NCR-Fwd. For example, when the offset (e.g., scheduling offset) of reception of the DCI from the CSI-RS corresponding to/triggered by the DCI is less than a threshold (e.g., beamSwitchTiming, beamSwitchTiming-r16), the NCR-MT of the NCR determines the QCL assumption or TCI state of the CSI-RS according to the beam for the NCR-Fwd of the NCR. In other words, when the offset (e.g., scheduling offset) of reception of the DCI from the CSI-RS corresponding/triggered to the DCI is less than the threshold (e.g., timeDurationForQCL), the NCR-MT of the NCR determines that the TCI state/QCL assumption related to the NCR-Fwd of the NCR is the same as the TCI state/QCL assumption corresponding to the CSI-RS. In other words, when the offset (e.g., scheduling offset) of reception of the DCI from the CSI-RS corresponding to/triggered by the DCI is less than the threshold (e.g., timeDurationForQCL), the NCR-MT of the NCR determines that a reference signal related to the NCR-Fwd of the NCR and the CSI-RS are QCLed.

Optionally, Example 1-1 can be referred to for the definition/explanation of the beam for the NCR-Fwd.

Optionally, the CSI-RS refers to CSI-RS resources, for example, aperiodic CSI-RS resources.

Optionally, the offset (e.g., scheduling offset) of reception of the DCI from the CSI-RS corresponding to the DCI being less than the threshold, means that the offset between the last symbol carrying the PDCCH triggering the DCI and the first symbol of the aperiodic CSI-RS resources is less than the threshold.

Optionally, there is no other DL signal with the indicated TCI state in the same symbol as the CSI-RS, where the other DL signal refers to at least one of the followings:
a scheduled PDSCH with an offset greater than or equal to the threshold;
a periodic CSI-RS;
a semi-persistent CSI-RS;
a scheduled aperiodic CSI-RS with an offset greater than or equal to the threshold reported by the NCR-MT.

Optionally, the CSI-RS is not a tracking reference signal (TRS). For example, the resources (group) corresponding to the CSI-RS is not configured with a parameter trs-Info.

For the method provided in Example 2-1, the NCR also satisfies the following condition: the NCR-Fwd is turned on in time domain resources related to the CSI-RS (that is, the NCR-Fwd performs downlink reception and/or downlink forwarding in the time domain resources related to the CSI-RS).

When the NCR-Fwd is not turned on in the time domain resources related to the CSI-RS, the default reception beam for the NCR-MT is at least one of the followings:
a QCL assumption corresponding to the CORESET with the lowest ID in the latest slot on an active BWP. Optionally, on the active BWP, at least one CORESET is monitored;
a TCI state with the lowest ID for PDSCH on an active BWP. Optionally, on the active BWP, no CORESET is monitored.

Example 2-2 (NCR-MT, CSI-RS)

In this example, take a CSI-RS as an example of the channel or signal. Take the beam for the NCR-MT as an example of the beam for the NCR-Fwd or the NCR-MT.

The NCR determines the default beam for the NCR-MT to receive the CSI-RS according to the beam for the NCR-Fwd. For example, when the offset (e.g., scheduling offset) of reception of the DCI from the CSI-RS corresponding to/triggered by the DCI is less than a threshold (e.g., beamSwitchTiming, beamSwitchTiming-r16), the NCR-MT of the NCR determines the QCL assumption or TCI state of the CSI-RS according to the beam for the NCR-MT of the NCR. In other words, when the offset (e.g., scheduling offset) of reception of the DCI from the CSI-RS corresponding to/triggered by the DCI is less than the threshold (e.g., timeDurationForQCL), the NCR-MT of the NCR determines that the TCI state/QCL assumption related to the NCR-MT of the NCR is the same as the TCI state/QCL assumption corresponding to the CSI-RS. In other words, when the offset (e.g., scheduling offset) of reception of the DCI from the CSI-RS corresponding to/triggered by the DCI is less than the threshold (e.g., timeDurationForQCL), the NCR-MT of the NCR determines that a reference signal related to the NCR-MT of the NCR and the CSI-RS are QCLed.

Optionally, Example 1-2 can be referred to for the definition/explanation of the beam for the NCR-MT.

Optionally, the CSI-RS refers to CSI-RS resources, for example, aperiodic CSI-RS resources.

Optionally, the offset (e.g., scheduling offset) of reception of the DCI from the CSI-RS corresponding to the DCI being less than the threshold, means that the offset between the last symbol carrying the PDCCH triggering the DCI and the first symbol of the aperiodic CSI-RS resources is less than the threshold.

Optionally, there is no other DL signal with the indicated TCI state in the same symbol as the CSI-RS, where the other DL signal refers to at least one of the followings:
a scheduled PDSCH with an offset greater than or equal to the threshold;
a periodic CSI-RS;
a semi-persistent CSI-RS;
a scheduled aperiodic CSI-RS with an offset greater than or equal to the threshold reported by the UE.

Optionally, the CSI-RS is not a TRS. For example, the resources (group) corresponding to the CSI-RS is not configured with a parameter trs-Info.

For the method provided in Example 2-2, the NCR also satisfies the following condition: the NCR-Fwd is turned on in time domain resources related to the CSI-RS (that is, the NCR-Fwd performs downlink reception and/or downlink forwarding in the time domain resources related to the CSI-RS).

When the NCR-Fwd is not turned on in the time domain resources related to the CSI-RS, the default reception beam for the NCR-MT is at least one of the followings:
a QCL assumption corresponding to the CORESET with the lowest ID in the latest slot on an active BWP. Optionally, on the active BWP, at least one CORESET is monitored;
a TCI state with the lowest ID for the PDSCH on an active BWP.

Optionally, on the active BWP, no CORESET is monitored.

For Embodiment 1 (or a method of an example in Embodiment 1), optionally, methods described in each example of Embodiment 1 can be performed only when the NCR satisfies at least one of the following conditions:
the NCR-Fwd is turned on; specifically,
Explanation #1. The NCR-Fwd is turned on in the time domain resources related to the channel or signal (that is, the NCR-Fwd performs downlink reception and/or downlink forwarding in the time domain resources related to the channel or signal);
Optionally, time domain resources refer to slots/symbols/subframes, for example, slots/symbols/subframes where the channel is located, at least one or all slots/symbols/subframes of the channel or signal.

Explanation #2. The NCR-Fwd is turned on in the time domain resources of the DCI related to and/or corresponding to the channel or signal (that is, the NCR-Fwd performs downlink reception and/or downlink forwarding in the time domain resources of the DCI related to and/or corresponding to the channel or signal);

Optionally, the time domain resources refer to slots/symbols/subframes, for example, the slots/symbols/subframes where the channel is located, at least one or all slots/symbols/subframes of the channel or signal, at least one or all slots/symbols/subframes of the PDCCH corresponding to the DCI that triggers/schedules the channel.

Optionally, the NCR-Fwd being turned on means that the NCR-Fwd performs at least one of downlink reception, downlink forwarding, uplink reception and uplink forwarding.

For Embodiment 1, optionally, methods described in examples of Embodiment 1 can be performed only when the NCR satisfies at least one of the following conditions:

the NCR transmits/reports capability information to the base station. Wherein, the capability information refers to at least one of the followings:

the NCR (or the NCR-MT) does not support simultaneous reception of different QCL-typeD reference signals. In other words, the NCR does not support simultaneous use of different spatial parameters for reception by the NCR-MT and the NCR-Fwd;
the NCR supports beam sweeping (at the gNB side); in other words, the NCR-MT of the NCR supports beam sweeping;
the NCR supports adaptive beam (at the gNB side); in other words, the NCR-MT of the NCR supports adaptive beams;
the NCR supports beam correspondence; in other words, the NCR-MT of the NCR supports beam correspondence;
the NCR-MT and the NCR-Fwd of the NCR support independent/separate beam indication for the NCR-MT and the NCR-Fwd;
the NCR (or the NCR-MT) supports simultaneous reception of different QCL-typeD reference signals.
the NCR-MT of the NCR and the NCR-Fwd of the NCR operate in a same frequency range;
the NCR-MT of the NCR and the NCR-Fwd of the NCR operate in a same frequency band;
the NCR-MT of the NCR operates in the passband of the NCR-Fwd;
the NCR-MT of the NCR is provided with at least one TCI state; wherein, the TCI state includes a QCL-typeD reference signal;
the NCR-MT of the NCR is provided with a unified TCI type;
the NCR-MT of the NCR is in RRC Connected State;
the NCR (including the NCR-Fwd and the NCR-MT) operates in FR2.

Advantageous effects of Embodiment 1: Embodiment 1 provides an indication method for the default beam for the NCR-MT. This method enables the NCR to use the correct default beam (especially when the NCR-Fwd is turned on) to receive a signal and/or a channel of the NCR-MT. This method defines the default beam reception method for the NCR-MT, thus improving the link quality of the control link and the performance of the communication system.

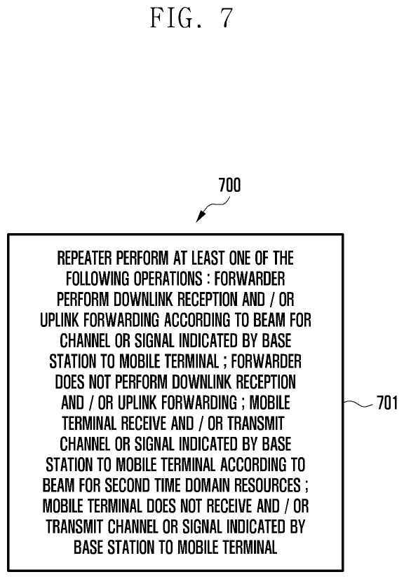

FIG. 7 illustrates a method performed by an NCR according to an embodiment of the disclosure.

Referring to FIG. 7, the NCR includes the NCR-MT and the NCR-Fwd.

The method 700 includes, at operation 701, if first time domain resources overlap with second time domain resources, the NCR performs at least one of the following operations: the NCR-Fwd performs downlink reception and/or uplink forwarding according to the beam for the channel or signal indicated by the base station to the NCR-MT; the NCR-Fwd does not perform downlink reception and/or uplink forwarding; the NCR-MT receives and/or transmits the channel or signal indicated by the base station to the NCR-MT according to the beam for the second time domain resources; the NCR-MT does not receive and/or transmit the channel or signal indicated by the base station to the NCR-MT, wherein: the first time domain resources are time domain resources for the channel or signal indicated by the base station to the NCR-MT; the second time domain resources are time domain resources used by the NCR-Fwd for downlink reception and/or uplink forwarding.

Embodiment 2 (Downlink Beam Collision Processing)

In this embodiment, the first time domain resources can be understood as the time domain resources in which the NCR-MT receives a channel or signal. The first time domain resources can also be understood as the time domain resources where the channel or signal of the NCR-MT is located. Optionally, the first time domain resources refer to a set of slots/symbols/subframes, for example, (at least one or all) slots/symbols/subframes where the channel is located. The second time domain resources can be understood as that the NCR-Fwd is turned on in the second time domain resources. Optionally, the second time domain resources refer to a set of slots/symbols/subframes, for example, a set of slots/symbols/subframes when the NCR-Fwd is turned on. Here, the NCR-Fwd is turned on means that the NCR-Fwd performs at least one of downlink reception, downlink forwarding, uplink reception and uplink forwarding. Optionally, the beam refers to at least one of a TCI state, QCL assumption, QCL parameters and a spatial filter.

The first time domain resources overlapping with the second time domain resources can be understood as that the NCR-Fwd is in an ON state (for example, performs downlink reception) in the first time domain resources (for example, all or a part of the first time domain resources). Optionally, the second time domain resources are a part of the first time domain resources. In this case, the NCR (the NCR-MT and/or the NCR-Fwd) performs at least one of the following operations:

Method 1

The NCR-Fwd performs downlink reception (preferably) according to the beam for the channel or signal.

Optionally, the NCR-Fwd performs downlink reception (preferably) according to the beam for the channel or signal in the time domain resources when the NCR-Fwd is turned on (or downlink reception is performed) in the first time domain resources.

Optionally, the NCR-Fwd performs downlink reception (preferably) according to the beam for the channel or signal in the first time domain resources.

Optionally, the NCR-Fwd performs downlink reception (preferably) according to the beam for the channel or signal in the second time domain resources.

Method 2

The NCR-Fwd does not perform downlink reception. Optionally, the NCR-Fwd stops downlink reception.

Optionally, the NCR-Fwd does not perform downlink reception in the time domain resources when the NCR-Fwd is turned on (in other words, downlink reception is performed) in the first time domain resources.

Optionally, the NCR-Fwd does not perform downlink reception in the first time domain resources.

Optionally, the NCR-Fwd does not perform downlink reception in the second time domain resources.

Method 3

The NCR-MT receives the channel or signal (preferably) according to the beam for the second time domain resources.

Optionally, the NCR-MT receives the channel or signal (preferably) according to the beam for the second time domain resources in the time domain resources when the NCR-Fwd is turned on (or downlink reception is performed) in the first time domain resources.

Optionally, the NCR-Fwd receives the channel or signal (preferably) in the first time domain resources according to the beam for the second time domain resources.

Optionally, the NCR-Fwd receives the channel or signal (preferably) in the second time domain resources according to the beam for the second time domain resources.

Method 4

The NCR-MT does not receive the channel or signal. Optionally, the NCR-MT stops receiving (and/or monitoring) the channel or signal.

Optionally, the NCR-MT does not receive the channel or signal in the time domain resources when the NCR-Fwd is turned on (or downlink reception is performed) in the first time domain resources.

Optionally, the NCR-MT does not receive the channel or signal in the first time domain resources.

Optionally, the NCR-MT does not receive the channel or signal in the second time domain resources.

Optionally, for the above Methods 1 to 4, the channel or signal refers to at least one of the followings:
a downlink signal and/or channel with the indicated TCI state
an SSB

Optionally, the SSB is determined by random access procedure.

Optionally, the random access procedure refers to initial access procedure. Optionally, the random access procedure refers to the random access procedure for beam failure recovery. Optionally, the random access procedure refers to the latest random access procedure. Optionally, the random access procedure refers to the random access procedure initiated by the reconfiguration with synchronization process.

Optionally, the SSB is determined by a MAC CE activation command Optionally, the MAC-CE is in a TCI state of an activated CORESET #0. Wherein the TCI state includes a CSI-RS. The CSI-RS and the SSB are QCLed.

Optionally, the SSB is used for NCR-Fwd beam sweeping (UE side beam sweeping, or access link beam sweeping).

Optionally, the SSB is determined by link recovery (beam failure recovery) procedure, and for example, the SSB can be grew.
a CSI-RS

Optionally, the CSI-RS is a periodic CSI-RS.

Optionally, the CSI-RS is a semi-persistent CSI-RS.

Optionally, the CSI-RS is an aperiodic CSI-RS.

Optionally, the offset (scheduling offset) of the aperiodic CSI-RS from the corresponding DCI is greater than or equal to a threshold (for example, beamSwitchTiming, beamSwitchTiming-r16).

Optionally, the CSI-RS is determined by random access procedure.

Optionally, the random access procedure refers to initial access procedure. Optionally, the random access procedure refers to the latest random access procedure. Optionally, the random access procedure refers to the random access procedure initiated by the reconfiguration with synchronization process.

Optionally, the CSI-RS is determined by link recovery (beam failure recovery) procedure, for example, the CSI-RS may be grew.

a PDCCH, which refers to at least one of the followings:

a PDCCH in CORESET(s); for example, the PDCCH monitored in CORESET #0.

a search space for PDCCH monitoring.

a PDSCH

Optionally, the offset between the PDSCH and the corresponding scheduling DCI is greater than or equal to a threshold (e.g., timeDurationForQCL).
a downlink channel or signal other than the PDSCH and an aperiodic CSI-RS.

Optionally, the offset between the PDSCH and the corresponding (scheduling) DCI is less than a threshold (e.g., TimedurationForQCL);

Optionally, the offset between the aperiodic CSI-RS resources and the corresponding (scheduling) DCI is less than a threshold (e.g., timeDurationForQCL or beamSwitchTiming).

For Embodiment 2, optionally, methods described in Embodiment 2 can be performed only when the NCR satisfies at least one of the following conditions:
the NCR transmits/reports capability information to the base station. Wherein, the capability information refers to that the NCR (or the NCR-MT) does not support simultaneous reception of different QCL-typeD reference signals. Optionally, the NCR does not support simultaneous use of different spatial parameters for reception by the NCR-MT and the NCR-Fwd;
The beam for the downlink signal/channel and the beam for the second time domain resources are different. Optionally, the beam refers to at least one of a QCL assumption, a TCI state and a reference signal (for example, a QCL-typeD reference signal).

For Embodiment 2, optionally, methods described in Embodiment 2 can be performed only when the NCR satisfies at least one of the following conditions:

the NCR transmits/reports capability information to the base station. Wherein, the capability information refers to at least one of the followings:

the NCR supports beam sweeping (at the gNB side); in other words, the NCR-MT of the NCR supports beam sweeping;
the NCR supports adaptive beam (at the gNB side); in other words, the NCR-MT of the NCR supports adaptive beams;
the NCR supports beam correspondence; in other words, the NCR-MT of the NCR supports beam correspondence;
the NCR-MT and the NCR-Fwd of the NCR support independent/separate beam indication for the NCR-MT and the NCR-Fwd;
the NCR (or the NCR-MT) supports simultaneous reception of different QCL-typeD reference signals.
the NCR-MT of the NCR and the NCR-Fwd of the NCR operate in a same frequency range;
the NCR-MT of the NCR and the NCR-Fwd of the NCR operate in a same frequency band;
the NCR-MT of the NCR operates in the passband of the NCR-Fwd;
the NCR-MT of the NCR is provided with at least one TCI state; wherein, the TCI state includes a QCL-typeD reference signal;
the NCR-MT of the NCR is provided with a unified TCI type;
the NCR-MT of the NCR is in RRC Connected State;
the NCR (including the NCR-Fwd and the NCR-MT) operates in FR2.

Advantageous effects of Embodiment 2: Embodiment 2 provides a method for processing downlink beam collision. This method enables the NCR to use the correct beam (especially when the NCR-Fwd is turned on) to perform operations of the NCR-MT and/or the NCR-Fwd. This method clarifies reception behaviors of the NCR-MT and/or the NCR-Fwd, thus improving the link quality of the control link and/or backhaul link and improving the performance of the communication system.

### Embodiment 3 (Uplink Beam Collision Processing)

In this embodiment, the first time domain resources can be understood as the time domain resources in which the NCR-MT transmits a channel or signal. The first time domain resources can also be understood as the time domain resources where the channel or signal of the NCR-MT is located. Optionally, the first time domain resources refer to a set of slots/symbols/subframes, for example, (at least one or all) slots/symbols/subframes where the channel is located. The second time domain resources can be understood as that the NCR-Fwd is turned on in the second time domain resources. Optionally, the second time domain resources refer to a set of slots/symbols/subframes, for example, a set of slots/symbols/subframes when the NCR-Fwd is turned on. Here, the NCR-Fwd is turned on means that the NCR-Fwd performs at least one of downlink reception, downlink forwarding, uplink reception and uplink forwarding. Optionally, the beam refers to at least one of a TCI state (for example, a joint TCI state or an uplink TCI state), spatial relationship, a SRI (a sounding reference signal (SRS) resources indication, or a spatial filter related to the SRS resources indication), QCL assumption, QCL parameters and a spatial filter.

The first time domain resources overlapping with the second time domain resource can be understood as that the NCR-Fwd is in an ON state (for example, performs uplink forwarding) in the first time domain resources (for example, all or a part of the first time domain resources). Optionally, the second time domain resources are a part of the first time domain resources. In this case, the NCR (the NCR-MT and/or the NCR-Fwd) performs at least one of the following operations:

Method 1

The NCR-Fwd performs uplink forwarding (preferably) according to the beam for the channel or signal.

Optionally, the NCR-Fwd performs uplink forwarding (preferably) according to the beam for the channel or signal in the time domain resources when the NCR-Fwd is turned on in the first time domain resources.

Optionally, the NCR-Fwd performs uplink forwarding (preferably) in the first time domain resources according to the beam for the channel or signal.

Optionally, the NCR-Fwd performs uplink forwarding (preferably) in the second time domain resources according to the beam for the channel or signal.

Method 2

The NCR-Fwd does not perform uplink forwarding, or optionally, the NCR-Fwd stops uplink forwarding.

Optionally, the NCR-Fwd does not perform uplink forwarding in the time domain resources during which the NCR-Fwd is turned on in the first time domain resources.

Optionally, the NCR-Fwd does not perform uplink forwarding in the first time domain resources.

Optionally, the NCR-Fwd does not perform uplink forwarding in the second time domain resources.

Method 3

The NCR-MT transmits the channel or signal (preferably) according to the beam for the second time domain resources.

Optionally, the NCR-MT transmits the channel or signal (preferably) according to the beam for the second time domain resources in the time domain resources when the NCR-Fwd is turned on (or uplink forwarding is performed) in the first time domain resources.

Optionally, the NCR-MT transmits the channel or signal in the first time domain resources (preferably) according to the beam for the second time domain resources.

Optionally, the NCR-MT transmits the channel or signal in the second time domain resources (preferably) according to the beam for the second time domain resources.

Method 4

NCR-MT does not transmit the channel or signal. In other words, the NCR-MT stops transmitting the channel or signal.

Optionally, the NCR-MT does not transmit the channel or signal in the time domain resources when the NCR-Fwd is turned on (or uplink forwarding is performed) in the first time domain resources.

Optionally, the NCR-MT does not transmit the channel or signal in the first time domain resources.

Optionally, the NCR-MT does not transmit the channel or signal in the second time domain resources.

Optionally, for the above methods, the channel or signal refers to at least one of the followings:
an uplink signal and/or a channel with the indicated TCI state
an SRS, which refers to at least one of the followings:

Optionally, the SRS is a periodic CSI-RS.

Optionally, the SRS is a semi-persistent CSI-RS.

Optionally, the SRS is an aperiodic CSI-RS.

Optionally, the SRS is used for beam management.

Optionally, the SRS is used for codebook-based physical uplink shared channel (PUSCH) transmission.

Optionally, the SRS is used for non-codebook-based PUSCH transmission.
a physical uplink control channel (PUCCH)
a PUSCH
a physical random access channel (PRACH)
a downlink channel or signal other than PRACH

For Embodiment 3, optionally, methods described in Embodiment 3 can be performed only when the NCR satisfies at least one of the following conditions:
the NCR transmits/reports capability information to the base station. Wherein, the capability information refers to at least one of the followings:
the NCR supports to perform simultaneous NCR-MT signal/channel transmission and NCR-Fwd DL Rx;
the NCR does not support to perform simultaneous NCR-MT signal/channel transmission and NCR-Fwd UL Tx using different spatial domain parameters (spatial relation);
the NCR (or the NCR-MT) does not support simultaneous reception of different QCL-typeD reference signals. In other words, the NCR does not support simultaneous use of different spatial parameters for reception by the NCR-MT and the NCR-Fwd.
the beam for the uplink signal/channel is different from the beam corresponding to the second time domain resources. Optionally, the beam refers to at least one of a QCL assumption, a TCI state (e.g., a joint TCI state or an uplink TCI state), spatial relationship and a reference signal (e.g., a QCL-typeD reference signal, e.g., an SRS).

For Embodiment 3, optionally, methods described in Embodiment 3 can be performed only when the NCR meets at least one of the following conditions:

the NCR transmits/reports capability information to the base station. Wherein the capability information refers to at least one of the followings:

the NCR supports beam sweeping (at the gNB side); in other words, the NCR-MT of the NCR supports beam sweeping;
the NCR supports adaptive beam (at the gNB side); in other words, the NCR-MT of the NCR supports adaptive beams;
the NCR supports beam correspondence; in other words, the NCR-MT of the NCR supports beam correspondence;
the NCR-MT and the NCR-Fwd of the NCR support independent/separate beam indication for the NCR-MT and the NCR-Fwd;
the NCR (or the NCR-MT) supports simultaneous reception of different QCL-typeD reference signals.
the NCR-MT of the NCR and NCR-Fwd of the NCR operate in a same frequency range;
the NCR-MT of the NCR and NCR-Fwd of the NCR operate in a same frequency band;
the NCR-MT of the NCR operates in the passband of the NCR-Fwd;
the NCR-MT of the NCR is provided with at least one TCI state; wherein, the TCI state includes a QCL-typeD reference signal;
the NCR-MT of the NCR is provided with a unified TCI type;
the NCR-MT of the NCR is in RRC Connected State;
the NCR (including the NCR-Fwd and the NCR-MT) operates in FR2.

Advantageous effects of Embodiment 3: Embodiment 3 provides a processing method for uplink beam collision. This method enables the NCR to use the correct beam (especially when NCR-Fwd is turned on) to perform operations of the NCR-MT and/or the NCR-Fwd. This method clarifies transmission behaviors of the NCR-MT and/or the NCR-Fwd, thus improving the link quality of the control link and/or backhaul link and improving the performance of the communication system.

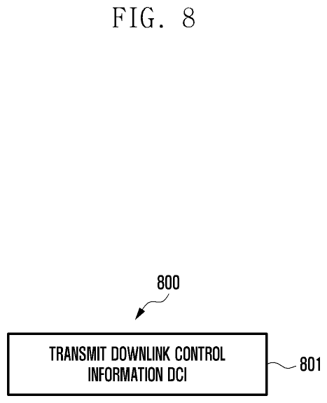

FIG. 8 illustrates a method performed by a base station according to an embodiment of the disclosure.

Referring to FIG. 8, a method 800 includes, at operation 801, transmitting downlink control information DCI to a repeater, wherein when the offset between the DCI and a channel or signal scheduled by the DCI is less than a threshold, a beam used for the repeater to receive the channel or signal is determined according to a beam for the repeater.

The mobile terminal NCR-MT and the NCR-Fwd of the repeater shown in FIG. 5 are respectively configured to perform corresponding methods disclosed herein.

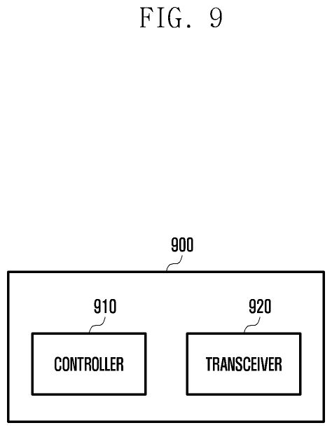

FIG. 9 illustrates a structure of a base station according to an embodiment of the disclosure.

Referring to FIG. 9, a base station 900 includes a controller 910 and a transceiver 920, wherein the controller 910 is configured to perform the method described in FIG. 8, and the transceiver 920 is configured to transmit and receive data or signals.

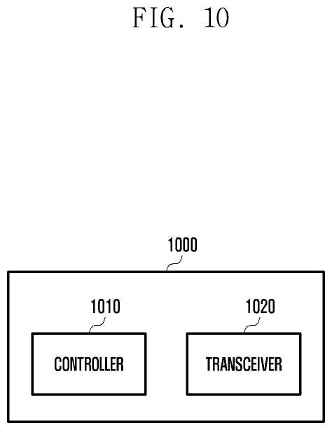

FIG. 10 illustrates a structure of a repeater according to an embodiment of the disclosure.

Referring to FIG. 10, a repeater 1000 includes a controller 1010 and a transceiver 1020, wherein the controller 1010 is configured to perform corresponding methods disclosed herein, and the transceiver 1020 is configured to transmit and receive data or signals.

In this disclosure, the channel or signal described above is indicated by the base station to the repeater.

### Embodiment 4

The NCR-Fwd and the NCR-MT perform downlink reception or uplink transmission simultaneously in a first slot/symbol (in other words, the control link (C-link) of the NCR and the backhaul link of the NCR perform downlink reception or uplink transmission simultaneously in the (one/same one/same) first slot/symbol), and in the first slot/symbol, the NCR-Fwd:

uses/applies a first beam/first spatial filter (for reception or transmission);

or

uses/applies the same beam/spatial filter as the first beam/first spatial filter (for reception or transmission); or

uses/applies a TCI state or spatial relationship of the NCR-MT/the control link (for reception or transmission); or

uses/applies the same TCI state or spatial relationship as that of the NCR-MT/the control link (for reception or transmission).

Optionally, the first beam/first spatial filter is used by the NCR-MT/the control link (in the first slot/symbol).

Optionally, the first slot/symbol refers to the slot/symbol of the NCR-Fwd. Optionally, the first slot/symbol refers to the slot/symbol of the NCR-MT. Optionally, the subcarrier spacing (SCS) of the first slot/symbol is determined based on the SCS of the NCR-MT (for example, it is the same as the SCS/SCS configuration of a PCell (for example, an active BWP of a PCell) of the NCR-MT). Optionally, the subcarrier spacing (SCS) of the first slot/symbol is determined based on the SCS of the NCR-Fwd (for example, the SCS of the forwarding time domain resources for NCR-Fwd, as another example, reference SCS for the NCR-Fwd).

Optionally, the first slot/symbol is the slot/symbol with reference to the NCR-Fwd (for example, a reference slot/symbol of the NCR-Fwd. For another example, the indicated/configured reference slot/symbol of the NCR-Fwd). Optionally, the first slot/symbol is the slot/symbol with reference to the NCR-MT (for example, a slot/symbol of a PCell of the NCR-MT).

Optionally, otherwise, or when the NCR-Fwd and the NCR-MT do not perform downlink reception or uplink transmission simultaneously in the first slot/symbol or the second slot/symbol, the TCI state/spatial relationship/beam/spatial filter of the NCR-Fwd in the first slot/symbol or the second slot/symbol is determined based on the followings:
the TCI state or spatial relationship indicated by the base station (for example, the TCI state or spatial relationship for the NCR-Fwd); or
a predefined TCI state (e.g., of the NCR-MT) (e.g., the latest PDSCH TCI state of the NCR-MT. For another example, the activated PDSCH TCI state with the smallest ID of the NCR-MT) or a predefined spatial relationship (e.g., spatial relationship of dedicated PUCCH resources with the smallest ID of the NCR-MT).

Optionally, the second slot/symbol refers to the slot/symbol of the NCR-Fwd. Optionally, the second slot/symbol refers to the slot/symbol of the NCR-MT. Optionally, the subcarrier spacing (SCS) of the second slot/symbol is determined based on the SCS of the NCR-MT (for example, it is the same as the SCS/SCS configuration of a PCell (for example, an active BWP of a PCell) of the NCR-MT). Optionally, the subcarrier spacing (SCS) of the second slot/symbol is determined based on the SCS of the NCR-Fwd (for example, the SCS of the forwarding time domain resources for NCR-Fwd. For another example, the reference SCS for the NCR-Fwd).

Optionally, the second slot/symbol is the slot/symbol with reference to the NCR-Fwd (for example, a reference slot/symbol of the NCR-Fwd. For another example, the indicated/configured reference slot/symbol of the NCR-Fwd). Optionally, the second slot/symbol is the slot/symbol referring to the NCR-MT (for example, a slot/symbol of a PCell of the NCR-MT).

Advantageous effects: the embodiment provides a beam handling method. This method enables the NCR to use the correct beam to perform operations of the NCR-MT and/or the NCR-Fwd. This method clarifies transmission behaviors of the NCR-MT and/or the NCR-Fwd, thus improving the link quality of the control link and/or backhaul link and improving the performance of the communication system.

### Embodiment 5

The NCR-Fwd and the NCR-MT perform downlink reception or uplink transmission simultaneously in a first slot/symbol (in other words, the control link (C-link) of the NCR and the backhaul link of the NCR perform downlink reception or uplink transmission simultaneously in the (one/same one/same) first slot/symbol), and in the first slot/symbol, the NCR-MT:

uses/applies a first beam/first spatial filter (for reception or transmission);

or

uses/applies the same beam/spatial filter as the first beam/first spatial filter (for reception or transmission); or

uses/applies a TCI state or spatial relationship of the NCR-Fwd/the backhaul link (for reception or transmission); or

uses/applies the same TCI state or spatial relationship as that of the NCR-Fwd/the backhaul link (for reception or transmission).

Optionally, the first beam/first spatial filter is used by the NCR-Fwd/the backhaul link (in the first slot/symbol).

Optionally, the first slot/symbol refers to the slot/symbol of the NCR-Fwd. Optionally, the first slot/symbol refers to the slot/symbol of the NCR-MT. Optionally, the subcarrier spacing (SCS) of the first slot/symbol is determined based on the SCS of the NCR-MT (for example, it is the same as the SCS/SCS configuration of a PCell (for example, an active BWP of a PCell) of the NCR-MT). Optionally, the subcarrier spacing (SCS) of the first slot/symbol is determined based on the SCS of the NCR-Fwd (for example, the SCS of the forwarding time domain resources for NCR-Fwd, as another example, reference SCS for the NCR-Fwd).

Optionally, the first slot/symbol is the slot/symbol with reference to the NCR-Fwd (for example, a reference slot/symbol of the NCR-Fwd. For another example, the indicated/configured reference slot/symbol of the NCR-Fwd). Optionally, the first slot/symbol is the slot/symbol with reference to the NCR-MT (for example, a slot/symbol of a PCell of the NCR-MT).

Optionally, otherwise, or when the NCR-Fwd and the NCR-MT do not perform downlink reception or uplink transmission simultaneously in the first slot/symbol or the second slot/symbol, the TCI state/spatial relationship/beam/spatial filter of the NCR-Fwd in the first slot/symbol or the second slot/symbol is determined based on the followings:
the TCI state or spatial relationship indicated by the base station (for example, the TCI state or spatial relationship for the NCR-Fwd); or
a predefined TCI state (e.g., of the NCR-MT) (e.g., the latest PDSCH TCI state of the NCR-MT. For another example, the activated PDSCH TCI state with the smallest ID of the NCR-MT) or a predefined spatial relationship (e.g., spatial relationship of dedicated PUCCH resources with the smallest ID of the NCR-MT).

Optionally, the second slot/symbol refers to the slot/symbol of the NCR-Fwd. Optionally, the second slot/symbol refers to the slot/symbol of the NCR-MT. Optionally, the subcarrier spacing (SCS) of the second slot/symbol is determined based on the SCS of the NCR-MT (for example, it is the same as the SCS/SCS configuration of a PCell (for example, an active BWP of a PCell) of the NCR-MT). Optionally, the subcarrier spacing (SCS) of the second slot/symbol is determined based on the SCS of the NCR-Fwd (for example, the SCS of the forwarding time domain resources for NCR-Fwd. For another example, the reference SCS for the NCR-Fwd).

Optionally, the second slot/symbol is the slot/symbol with reference to the NCR-Fwd (for example, a reference slot/symbol of the NCR-Fwd. For another example, the indicated/configured reference slot/symbol of the NCR-Fwd). Optionally, the second slot/symbol is the slot/symbol referring to the NCR-MT (for example, a slot/symbol of a PCell of the NCR-MT).

Advantageous effects: the embodiment provides a beam handling method. This method enables the NCR to use the correct beam to perform operations of the NCR-MT and/or the NCR-Fwd. This method clarifies transmission behaviors of the NCR-MT and/or the NCR-Fwd, thus improving the link quality of the control link and/or backhaul link and improving the performance of the communication system.

It can also be understood that “at least one/at least one” described in this disclosure includes any and/or all possible combinations of listed items, various embodiments described in this disclosure and various examples in embodiments can be changed and combined in any suitable form, and “/” described in this disclosure means “and/or”.

Furthermore, it can be understood that the beam ID can be understood as a logical beam ID. For example, the repeater described in this disclosure can also be understood as a reconfigurable intelligent surface (RIS), and the corresponding method can also be applied to the intelligent hypersurface.

The illustrative logical blocks, modules, and circuits described in this disclosure may be implemented in a general-purpose processor, a digital signal processor (DSP), an application specific integrated circuit (ASIC), field programmable gate array (FPGA) or other programmable logic devices, discrete gate or transistor logic, discrete hardware components, or any combination thereof designed to perform the functions described herein. A general-purpose processor may be a microprocessor, but in the alternative, the processor may be any processor of the related art, controller, microcontroller, or state machine. A processor may also be implemented as a combination of computing devices, such as a combination of a DSP and a microprocessor, a plurality of microprocessors, one or more microprocessors cooperating with a DSP core, or any other such configuration.

The steps of a method or algorithm described in this disclosure may be embodied directly in hardware, in a software module performed by a processor, or in a combination of the both. Software modules may reside in a RAM memory, a flash memory, a ROM memory, an erasable programmable ROM (EPROM) memory, an electrically EPROM (EEPROM) memory, registers, hard disks, removable disks, or any other form of storage media known in the art. A storage medium is coupled to a processor to enable the processor to read and write information from/to the storage medium. In the alternative, the storage medium may be integrated into the processor. The processor and storage medium may reside in an ASIC. The ASIC may reside in the user terminal. In the alternative, the processor and the storage medium may reside as separate components in the user terminal.

In one or more designs, the described functions may be implemented in hardware, software, firmware, or any combination thereof. If implemented in software, each function can be stored on or transmitted by a computer-readable medium as one or more instructions or codes. Computer-readable media include both computer storage media and communication media, and the latter includes any media that facilitates the transfer of computer programs from one place to another. The storage medium can be any available medium that can be accessed by a general-purpose or special-purpose computer.

The description set forth herein, taken in conjunction with the drawings, describes example configurations, methods and devices, and does not represent all examples that can be realized or are within the scope of the claims. As used herein, the term “example” means “serving as an example, instance or illustration” rather than “preferred” or “superior to other examples”. The detailed description includes specific details in order to provide an understanding of the described technology. However, these techniques may be practiced without these specific details. In some cases, well-known structures and devices are shown in block diagram form to avoid obscuring the concepts of the described examples.

Although this specification contains many specific implementation details, these should not be interpreted as limitations on any embodiment or the scope of the claimed protection, but as descriptions of specific features of specific embodiments. Some features described in this specification in the context of separate embodiments can also be combined in a single embodiment. On the contrary, various features described in the context of a single embodiment can also be implemented separately in multiple embodiments or in any suitable sub-combination. Furthermore, although features may be described above as functioning in certain combinations, and even initially claimed as such, in some cases, one or more features from the claimed combination may be deleted from the combination, and the claimed combination may be directed to a subcombination or a variation of a subcombination.

It should be understood that the specific order or hierarchy of steps in the method of the disclosure is illustrative of a process. Based on the design preference, it can be understood that the specific order or hierarchy of steps in the method can be rearranged to realize the functions and effects disclosed in the disclosure. The appended method claims elements of various steps in an example order, and are not meant to be limited to the particular order or hierarchy presented, unless otherwise specifically stated. Therefore, the disclosure is not limited to the illustrated examples, and any means for performing the functions described herein are included in various aspects of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a repeater, the repeater comprising a first unit and a second unit, the method comprising:
receiving, by the first unit, downlink control information (DCI) from a base station; and
based on an offset between the DCI and a first channel scheduled by the DCI being less than a threshold, identifying, by the first unit, a beam for the first unit to receive the first channel according to a beam for the second unit or a beam for the first unit.

2. The method of claim 1, wherein the second unit is configured to perform downlink reception in time domain resources of the first channel scheduled by the DCI.

3. The method of claim 1, further comprising:
providing, by the first unit, repeater capability information to the base station, the repeater capability information indicating at least one of:
the repeater not supporting to simultaneously perform reception of the first channel by the first unit and downlink reception by the second unit using different spatial parameters;
the repeater supporting beam sweeping;
the repeater supporting adaptive beams;
the repeater supporting beam correspondence; or
the repeater supporting independent beam indication for the first unit and the second unit.

4. The method of claim 1, wherein the beam for the second unit, at least one of the beam for the first unit or the beam for the first unit to receive the first channel comprises at least one of:
a spatial filter;
a quasi-co-location (QCL) assumption;
a QCL parameter;
a transmission control indication (TCI) state; or
spatial relationship.

5. The method of claim 1, wherein based on first time domain resources overlap with second time domain resources, further comprises at least one of:
performing, by the second unit, at least one of downlink reception or uplink forwarding according to a beam for a second channel indicated by a base station to the first unit;
identifying not to perform, by the second unit, the at least one of downlink reception or uplink forwarding;
communicating, by the first unit, the second channel indicated by the base station to the first unit according to a beam for the second time domain resource; and
identifying not to communicate, by the first unit, the second channel indicated by the base station to the first unit,
wherein the first time domain resources are time domain resources for the second channel indicated by the base station to the first unit, and
wherein the second time domain resources are time domain resources used by the second unit for at least one of downlink reception or uplink forwarding.

6. The method of claim 5, wherein the beam for the second channel is different from the beam for the second time domain resources.

7. The method of claim 5, wherein the performing, by the second unit, at least one of downlink reception or uplink forwarding comprises at least one of:
performing, by the second unit, the at least one of downlink reception or uplink forwarding according to the beam for the second channel in an overlapping portion of the first time domain resources and the second time domain resources;
performing, by the second unit, the at least one of downlink reception or uplink forwarding in the first time domain resources according to the beam for the second channel; or
performing, by the second unit, the at least one of downlink reception or uplink forwarding in the second time domain resources according to the beam for the second channel.

8. The method of claim 5, wherein the identifying not to perform, by the second unit, the at least one of downlink reception or uplink forwarding comprises at least one of:
identifying not to perform, by the second unit, the at least one of downlink reception or uplink forwarding in an overlapping portion of the first time domain resources and the second time domain resources;
identifying not to perform, by the second unit, the at least one of downlink reception or uplink forwarding in the first time domain resources; or
identifying not to perform, by the second unit, the at least one of downlink reception or uplink forwarding in the second time domain resources.

9. The method of claim 5, wherein the communicating, by the first unit, the second channel indicated by the base station to the first unit comprises at least one of:
communicating, by the first unit, the second channel according to the beam for the second time domain resources in an overlapping portion of the first time domain resources and the second time domain resources;
communicating, by the first unit, the second channel in the first time domain resources according to the beam for the second time domain resources; or
communicating, by the first unit, the second channel in the second time domain resources according to the beam for the second time domain resources.

10. The method of claim 5, wherein the identifying not to communicate, by the first unit, the second channel indicated by the base station to the first unit comprises at least one of:
identifying not to communicate, by the first unit, transmitting the second channel in an overlapping portion of the first time domain resources and the second time domain resources;
identifying not to communicate, by the first unit, the second channel in the first time domain resources; and
identifying not to communicate, by the first unit, the second channel in the second time domain resources.

11. A method performed by a base station, the method comprising:
transmitting downlink control information downlink control information (DCI) to a repeater; and
based on an offset between the DCI and a first channel scheduled by the DCI being less than a threshold, determining a beam for the repeater to receive the first channel according to a beam for the repeater.

12. A repeater comprising:
a first unit; and
a second unit,
wherein the repeater is configured to:
receive, by the first unit, downlink control information (DCI) from a base station, and
based on an offset between the DCI and a first channel scheduled by the DCI being less than a threshold, identify, by the first unit, a beam for the first unit to receive the first channel according to a beam for the second unit or a beam for the first unit.

13. The repeater of claim 12, wherein the second unit is configured to perform downlink reception in time domain resources of the first channel scheduled by the DCI.

14. The repeater of claim 12, wherein the repeater is further configured to:
provide, by the first unit, repeater capability information to the base station, the repeater capability information indicating at least one of:
the repeater not supporting to simultaneously perform reception of the first channel by the first unit and downlink reception by the second unit using different spatial parameters;
the repeater supporting beam sweeping;
the repeater supporting adaptive beams;
the repeater supporting beam correspondence; or
the repeater supporting independent beam indication for the first unit and the second unit.

15. The repeater of claim 12, wherein the beam for the second unit, at least one of the beam for the first unit or the beam for the first unit to receive the first channel comprises at least one of:
a spatial filter;
a quasi-co-location (QCL) assumption;
a QCL parameter;
a transmission control indication (TCI) state; or
spatial relationship.

16. The repeater of claim 12, wherein, based on first time domain resources overlap with second time domain resources, the repeater is further configured to perform at least one of:
performing, by the second unit, at least one of downlink reception or uplink forwarding according to a beam for a second channel indicated by a base station to the first unit,
identifying not to perform, by the second unit, the at least one of downlink reception or uplink forwarding,
communicating, by the first unit, the second channel indicated by the base station to the first unit according to a beam for the second time domain resources, or
identifying not to communicate, by the first unit, the second channel indicated by the base station to the first unit,
wherein the first time domain resources are time domain resources for the second channel indicated by the base station to the first unit, and
wherein the second time domain resources are time domain resources used by the second unit for at least one of downlink reception or uplink forwarding.

17. The repeater of claim 16, wherein the beam for the second channel is different from the beam for the second time domain resources.

18. The repeater of claim 16, wherein the repeater is further configured to perform at least one of:
performing, by the second unit, the at least one of downlink reception or uplink forwarding according to the beam for the second channel in an overlapping portion of the first time domain resources and the second time domain resources,
performing, by the second unit, the at least one of downlink reception or uplink forwarding in the first time domain resources according to the beam for the second channel, or
performing, by the second unit, the at least one of downlink reception or uplink forwarding in the second time domain resources according to the beam for the second channel.

19. The repeater of claim 16, wherein the repeater is further configured to perform at least one of:
identifying not to perform, by the second unit, the at least one of downlink reception or uplink forwarding in an overlapping portion of the first time domain resources and the second time domain resources,
identifying not to perform, by the second unit, the at least one of downlink reception or uplink forwarding in the first time domain resources, or
identifying not to perform, by the second unit, the at least one of downlink reception or uplink forwarding in the second time domain resources.

20. A base station comprising:
a transceiver; and
at least one processor coupled to the transceiver,
wherein the at least one processor is configured to:
transmit downlink control information downlink control information (DCI) to a repeater, and
based on an offset between the DCI and a first channel scheduled by the DCI being less than a threshold, determine a beam for the repeater to receive the first channel according to a beam for the repeater.
